(19) United States
(12) Patent Application Publication
(10) Pub. No.: US 2025/0166946 A1
(43) Pub. Date: May 22, 2025

(54) POWER WINDOW SWITCH APPARATUS

(71) Applicants: HYUNDAI MOTOR COMPANY, Seoul (KR); KIA CORPORATION, Seoul (KR)

(72) Inventors: Man Deok Lee, Incheon (KR); Hyun Song, Hwaseong-si (KR)

(73) Assignees: HYUNDAI MOTOR COMPANY, Seoul (KR); KIA CORPORATION, Seoul (KR)

(21) Appl. No.: 18/666,033

(22) Filed: May 16, 2024

(30) Foreign Application Priority Data
Nov. 16, 2023 (KR) 10-2023-0159400

(51) Int. Cl. H01H 23/14; H01H 23/00

(52) U.S. Cl. CPC H01H 23/14; H01H 23/006; H01H 2231/026; H01H 2300/01

(57) ABSTRACT

A power window switch apparatus includes: a switch housing; a first knob pivotally mounted on the switch housing by a first pivot pin; and a second knob pivotally mounted on the switch housing by a second pivot pin. In particular, a top surface of the second knob is located higher than a top surface of the first knob.

### CROSS-REFERENCE TO RELATED APPLICATION

This application claims the benefit of and priority to Korean Patent Application No. 10-2023-0159400, filed on Nov. 16, 2023, in the Korean Intellectual Property Office, the disclosure of which is incorporated herein in its entirety by reference.

### TECHNICAL FIELD

The present disclosure relates to a power window switch apparatus to improve the.

### BACKGROUND

A vehicle includes a plurality of doors, and the plurality of doors include a pair of front doors and a pair of rear doors. The pair of front doors may be disposed on both left and right sides of a front portion of the vehicle, respectively. The pair of rear doors may be disposed on both left and right sides of a rear portion of the vehicle, respectively. A pair of front windows may be provided to the pair of front doors, respectively, and a pair of rear windows may be provided to the pair of rear doors, respectively. The pair of front windows and the pair of rear windows may move upwards and downwards by the corresponding window drive mechanisms.

Each window drive mechanism may be controlled by a power window switch apparatus, and the power window switch apparatus may be mounted on an armrest of each door. The power window switch apparatus may have a plurality of knobs for controlling the operations of a plurality of window glasses, respectively. The plurality of knobs may include a pair of front knobs for operating the pair of front windows, respectively, and a pair of rear knobs for operating the pair of rear windows, respectively.

In the power window switch apparatus according to the related art, however, the pair of front knobs and the pair of rear knobs may be located at the same height. Accordingly, if a driver operates the knobs without looking at them with the naked eye, it may be difficult for the driver to accurately perceive the pair of front knobs and the pair of rear knobs. As a result, the driver may often poorly operate the pair of front windows and the pair of rear windows. In other words, it is not easy for the user to intuitively operate the related art power window switch apparatus.

In addition, the pair of front knobs and the pair of rear knobs may be located at the same height, and a sufficient distance between each front knob and the corresponding rear knob should be secured, so the size of the power window switch apparatus may be relatively increased. Accordingly, the power window switch apparatus may take up a relatively large area on the armrest of the door. As a result, a support area of the armrest supporting the user's arm or hand may become relatively narrow.

The above information described in this background section is provided to assist in understanding the background of the inventive concept, and may include any technical concept which is not considered as the prior art that is already known to those having ordinary skill in the art.

### SUMMARY

The present disclosure has been made to solve the above-mentioned problems occurring in the prior art while advantages achieved by the prior art are maintained intact.

An aspect of the present disclosure provides a power window switch apparatus designed to have knobs at different heights, thereby facilitating intuitive operation of the knobs.

According to an aspect of the present disclosure, a power window switch apparatus may include: a switch housing; and a first knob pivotally mounted on the switch housing by a first pivot pin. The power window switch apparatus may further include a second knob pivotally mounted on the switch housing by a second pivot pin. A top surface of the second knob may be located higher than a top surface of the first knob.

In one embodiment, the power window switch apparatus may further include: a first front operating piece extending vertically and disposed below a front portion of the first knob; and a first rear operating piece extending vertically and disposed below a rear portion of the first knob. The power window switch apparatus may also include: a first front detector located below the first front operating piece; and a first rear detector located below the first rear operating piece.

In another embodiment, the first front operating piece may be located in front of the first pivot pin, and the first rear operating piece may be located behind the first pivot pin.

The power window switch apparatus may further include: a second front operating piece extending vertically and disposed below a front portion of the second knob; and a second rear operating piece extending vertically and disposed below a rear portion of the second knob. The power window switch apparatus may further include: a second front detector located below the second front operating piece; and a second rear detector located below the second rear operating piece.

In one embodiment, the second front operating piece may be located in front of the second pivot pin, and the second rear operating piece may be located behind the second pivot pin.

In one embodiment, the power window switch apparatus may further include: a printed circuit board (PCB) extending horizontally in the switch housing. The first front detector, the first rear detector, the second front detector, and the second rear detector may be mounted on the PCB.

In one embodiment, the power window switch apparatus may further include a first rotating holder connected to the first knob to pivot in an opposite direction to the first knob, and the first rotating holder includes a first lower projection extending downwardly and a first upper projection extending upwardly. The power window switch apparatus may further include: a first lower operating piece aligned to contact the first lower projection of the first rotating holder; and a first upper operating piece aligned to contact the first upper projection of the first rotating holder. The power window switch apparatus may further include: a first lower detector connected to the first lower operating piece; and a first upper detector connected to the first upper operating piece.

The first knob may have a first connection pin provided on a rear portion thereof, and the first rotating holder may have a first recess receiving the first connection pin.

In another embodiment, the power window switch apparatus may further include a second rotating holder connected to the second knob to pivot in an opposite direction to the second knob, and the second rotating holder includes a second lower projection extending downwardly and a second upper projection extending upwardly. The power window switch apparatus may further include: a second lower operating piece aligned to contact the second lower projection of the second rotating holder; and a second upper operating piece aligned to contact the second upper projection of the second rotating holder. The power window switch apparatus may further include: a second lower detector connected to the second lower operating piece; and a second upper detector connected to the second upper operating piece.

The second knob may have a second connection pin provided on a rear portion thereof, and the second rotating holder may have a second recess receiving the second connection pin.

The power window switch apparatus may further include: a PCB extending vertically in the switch housing. The first lower detector, the first upper detector, the second lower detector, and the second upper detector may be mounted on the PCB.

### BRIEF DESCRIPTION OF THE DRAWINGS

The above and other objects, features and advantages of the present disclosure should be more apparent from the following detailed description taken in conjunction with the accompanying drawings:

FIG. 1 illustrates a plan view of a power window switch apparatus according to an embodiment of the present disclosure;

FIG. 2 illustrates a cross-sectional view, taken along line A-A of FIG. 1;

FIG. 3 illustrates a perspective view of a power window switch apparatus according to another embodiment of the present disclosure;

FIG. 4 illustrates a first knob, a first rotating holder, a first lower operating piece, a first upper operating piece, a first lower detector, a first upper detector, a second knob, a second rotating holder, a second lower operating piece, a second upper operating piece, a second lower detector, and a second upper detector in a power window switch apparatus according to another embodiment of the present disclosure;

FIG. 5 illustrates a state in which a first knob rotates clockwise and a first rotating holder rotates counterclockwise in a power window switch apparatus according to another embodiment of the present disclosure;

FIG. 6 illustrates a state in which a first knob rotates counterclockwise and a first rotating holder rotates clockwise in a power window switch apparatus according to another embodiment of the present disclosure; and

FIG. 7 illustrates a state in which each of first and second knobs is supported by a support member and a spring in a power window switch apparatus according to another embodiment of the present disclosure.

### DETAILED DESCRIPTION

Hereinafter, embodiments of the present disclosure are described in detail with reference to the accompanying drawings. In the drawings, the same reference numerals are used throughout to designate the same or equivalent elements. In addition, a detailed description of well-known techniques associated with the present disclosure is ruled out in order not to unnecessarily obscure the gist of the present disclosure.

Terms such as first, second, A, B, (a), and (b) may be used to describe the elements in embodiments of the present disclosure. These terms are only used to distinguish one element from another element, and the intrinsic features, sequence or order, and the like of the corresponding elements are not limited by the terms. Unless otherwise defined, all terms used herein, including technical or scientific terms, have the same meanings as those generally understood by those with ordinary knowledge in the field of art to which the present disclosure belongs. Such terms as those defined in a generally used dictionary are to be interpreted as having meanings equal to the contextual meanings in the relevant field of art, and are not to be interpreted as having ideal or excessively formal meanings unless clearly defined as having such in the present application.

When a component, device, element, or the like of the present disclosure is described as having a purpose or performing an operation, function, or the like, the component, device, or element should be considered herein as being “configured to” meet that purpose or to perform that operation or function.

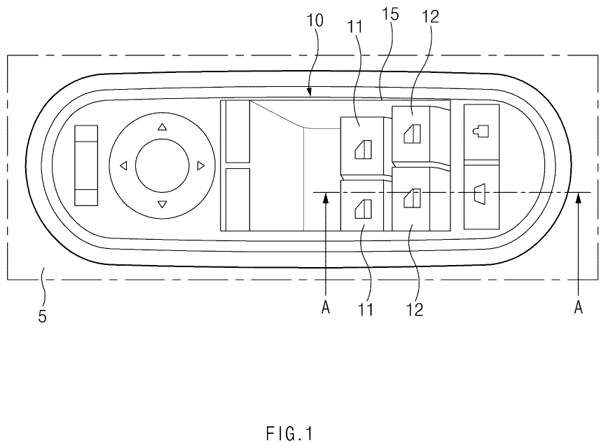

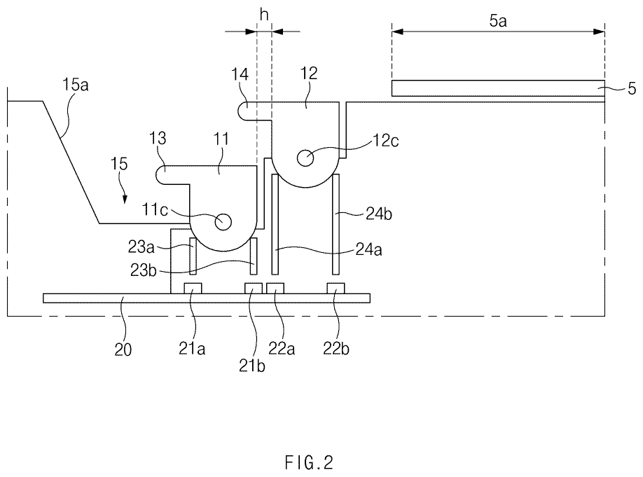

Referring to FIGS. 1 and 2, a power window switch apparatus 10 according to an embodiment of the present disclosure may be mounted on an armrest 5 or another portion of the vehicle.

Referring to FIGS. 1 and 2, the power window switch apparatus 10 may include a switch housing 15, and a pair of first knobs 11 and a pair of second knobs 12 disposed on the switch housing 15.

Referring to FIG. 2, the switch housing 15 may have a stepped form, and the switch housing 15 may be mounted on the armrest 5 or another portion of the vehicle. A cover 15a may cover a portion of the switch housing 15, and a printed circuit board (PCB) 20 may extend horizontally in the switch housing 15.

The first knob 11 may be pivotally mounted with respect to the switch housing 15 by a first pivot pin 11c. The first pivot pin 11c may be located in a lower middle portion of the first knob 11. According to an embodiment, the pair of first knobs 11 may be configured to control the vertical movement of a pair of front windows, respectively. The pair of front windows may be configured to move in a pair of front doors, respectively.

The first knob 11 may have a first projection 13 extending horizontally from a top end thereof. A first front operating piece 23a and a first rear operating piece 23b may be located below the first knob 11. The first front operating piece 23a may be aligned to contact a front portion of the first knob 11, and the first front operating piece 23a may extend vertically and disposed below the front portion of the first knob 11. The first front operating piece 23a may be elastically supported by an elastic member such as a coil spring. The first rear operating piece 23b may be aligned to contact a rear portion of the first knob 11, and the first rear operating piece 23b may extend vertically and be disposed below the rear portion of the first knob 11. The first rear operating piece 23b may be elastically supported by an elastic member such as a coil spring. The first front operating piece 23a may be located in front of the first pivot pin 11c, and the first rear operating piece 23b may be located behind the first pivot pin 11c.

A first front detector 21a may be located below the first front operating piece 23a, and a first rear detector 21b may be located below the first rear operating piece 23b. The PCB 20 may be located below the first knob 11 and the second knob 12, and the first front detector 21a and the first rear detector 21b may be mounted on the PCB 20. According to an embodiment, the first front detector 21a and the first rear detector 21b may be a tact switch having an elastic movable contact or an elastic member.

As the first knob 11 rotates counterclockwise around the first pivot pin 11c, the first front operating piece 23a may move vertically downwards so that the first front operating piece 23a may come into contact with the first front detector 21a, and accordingly the first front detector 21a may transmit a contact signal to a controller.

As the first knob 11 rotates clockwise around the first pivot pin 11c, the first rear operating piece 23b may move vertically downwards so that the first rear operating piece 23b may come into contact with the first rear detector 21b, and accordingly the first rear detector 21b may transmit a contact signal to the controller.

The second knob 12 may be pivotally mounted with respect to the switch housing 15 by a second pivot pin 12c. The second pivot pin 12c may be located in a lower middle portion of the second knob 12. According to an embodiment, the pair of second knobs 12 may be configured to control the vertical movement of a pair of rear windows, respectively. The pair of rear windows may be configured to move in a pair of rear doors, respectively.

The second knob 12 may have a second projection 14 extending horizontally from a top end thereof. A second front operating piece 24a and a second rear operating piece 24b may be located below the second knob 12. The second front operating piece 24a may be aligned to contact a front portion of the second knob 12, and the second front operating piece 24a may extend vertically and be disposed below the front portion of the second knob 12. The second front operating piece 24a may be elastically supported by an elastic member such as a coil spring. The second rear operating piece 24b may be aligned to contact a rear portion of the second knob 12, and the second rear operating piece 24b may extend vertically and be disposed below the rear portion of the second knob 12. The second rear operating piece 24b may be elastically supported by an elastic member such as a coil spring. The second front operating piece 24a may be located in front of the second pivot pin 12c, and the second rear operating piece 24b may be located behind the second pivot pin 12c.

A second front detector 22a may be located below the second front operating piece 24a, and a second rear detector 22b may be located below the second rear operating piece 24b. The second front detector 22a and the second rear detector 22b may be mounted on the PCB 20. According to an embodiment, the second front detector 22a and the second rear detector 22b may be a tact switch having an elastic movable contact or an elastic member.

As the second knob 12 rotates counterclockwise around the second pivot pin 12c, the second front operating piece 24a may move vertically downwards so that the second front operating piece 24a may come into contact with the second front detector 22a, and accordingly the second front detector 22a may transmit a contact signal to the controller.

As the second knob 12 rotates clockwise around the second pivot pin 12c, the second rear operating piece 24b may move vertically downwards so that the second rear operating piece 24b may come into contact with the second rear detector 22b. Accordingly, the second rear detector 22b may transmit a contact signal to the controller.

A top surface of the second knob 12 may be located higher than a top surface of the first knob 11, and accordingly the first knob 11 and the second knob 12 may be arranged in a stepwise manner. By designing the heights of the knobs 11 and 12 to be different from each other, intuitive operation of the knobs may be facilitated and enhanced, and thus operation errors thereof may be avoided or prevented.

The first knob 11 and the second knob 12 may be horizontally spaced apart from each other by a minimum distance “h” so that the first knob 11 and the second knob 12 may not interfere with each other. The second projection 14 of the second knob 12 may be at least partially overlapped with the rear portion of the first knob 11 so as to minimize the distance h between the first knob 11 and the second knob 12, thereby significantly reducing the length of the switch housing 15. For example, when the switch housing 15 is mounted on the armrest 5 of the vehicle, a support area 5a of the armrest 5 may be relatively increased as the length of the switch housing 15 is reduced.

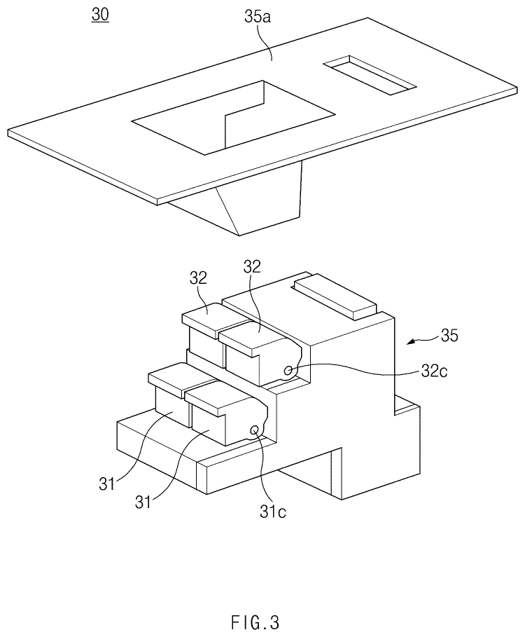

FIGS. 3 to 7 illustrate a power window switch apparatus 30 according to another embodiment of the present disclosure.

Referring to FIG. 3, the power window switch apparatus 30 may include a switch housing 35, and a pair of first knobs 31 and a pair of second knobs 32 disposed on the switch housing 35. The pair of second knobs 32 may be located higher than the pair of first knobs 31.

The switch housing 35 may have a stepped form, and the switch housing 35 may be mounted on the armrest 5 or another portion of the vehicle. A cover 35a may cover a portion of the switch housing 35. A PCB 40 may extend vertically, and the PCB 40 may be provided in the switch housing 35.

The first knob 31 may be pivotally mounted with respect to the switch housing 35 by a first pivot pin 31c. The first pivot pin 31c may be located in a lower portion of the first knob 31. According to an embodiment, the pair of first knobs 31 may be configured to control the vertical movement of the pair of front windows, respectively. The pair of front windows may be configured to move in the pair of front doors, respectively.

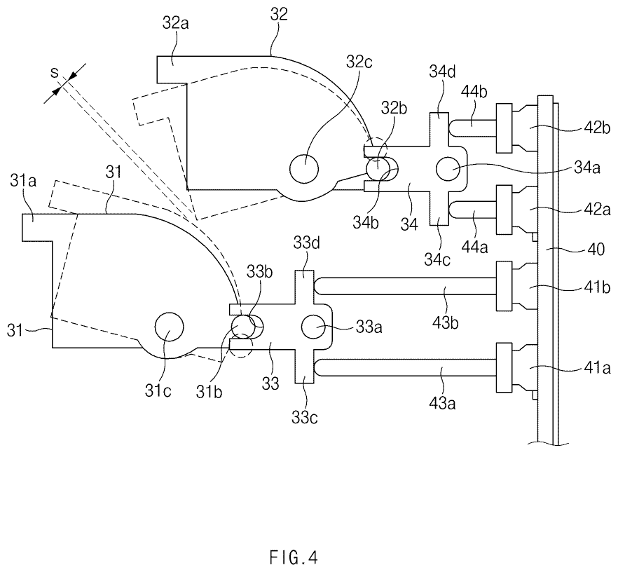

Referring to FIG. 4, the first knob 31 may include a first projection 31a provided on a front portion thereof, and a first connection pin 31b provided on a rear portion thereof. The first projection 31a may extend horizontally from the front portion of the first knob 31. The first connection pin 31b may be located behind the first pivot pin 31c, and the first connection pin 31b may have a circular cross section.

Referring to FIG. 4, a first rotating holder 33 may be horizontally aligned with the first knob 31, and the first rotating holder 33 may be connected to the first connection pin 31b of the first knob 31. The first rotating holder 33 may be pivotally mounted on the switch housing 35 by a pivot pin 33a. The first rotating holder 33 may have a first recess 33b receiving the first connection pin 31b of the first knob 31. The first recess 33b may be provided in a front portion of the first rotating holder 33, and the pivot pin 33a may be located behind the first recess 33b.

The first rotating holder 33 may be connected to the first knob 31 to pivot in the opposite direction to the first knob 31. Referring to FIG. 4, the first connection pin 31b of the first knob 31 may be received in the first recess 33b of the first rotating holder 33 so that the first knob 31 and the first rotating holder 33 may be pivotally connected to each other. The first connection pin 31b of the first knob 31 and the first recess 33b of the first rotating holder 33 may be located between the first pivot pin 31c of the first knob 31 and the pivot pin 33a of the first rotating holder 33.

Referring to FIG. 4, the first rotating holder 33 may include a first lower projection 33c extending downwardly from a bottom surface thereof, and a first upper projection 33d extending upwardly from a top surface thereof.

Referring to FIG. 4, a first lower operating piece 43a may be aligned to contact the first lower projection 33c of the first rotating holder 33, and the first lower operating piece 43a may extend horizontally. A first upper operating piece 43b may be aligned to contact the first upper projection 33d of the first rotating holder 33, and the first upper operating piece 43b may extend horizontally.

Referring to FIG. 4, a first lower detector 41a may be connected to the first lower operating piece 43a, and the first lower detector 41a may be horizontally aligned with the first lower operating piece 43a. A first upper detector 41b may be connected to the first upper operating piece 43b, and the first upper detector 41b may be horizontally aligned with the first upper operating piece 43b. The first lower detector 41a and the first upper detector 41b may be mounted on the PCB 40, and the first lower detector 41a may be located below the first upper detector 41b. According to an embodiment, the first lower detector 41a and the first upper detector 41b may be a tact switch having an elastic movable contact or an elastic member.

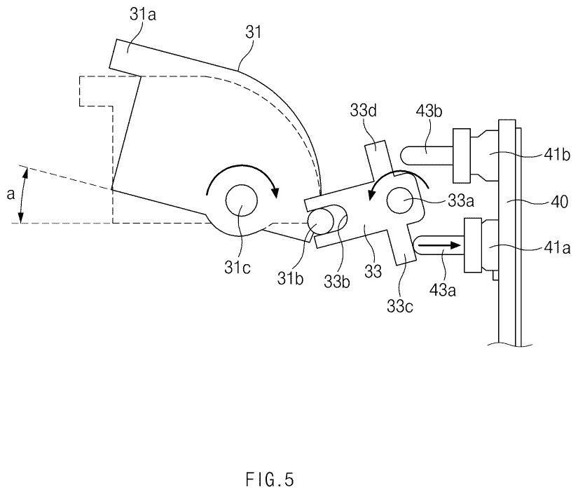

Referring to FIG. 5, when the first knob 31 rotates clockwise around the first pivot pin 31c, the first connection pin 31b of the first knob 31 may push the first recess 33b of the first rotating holder 33 downwards so that the first rotating holder 33 may rotate counterclockwise around the pivot pin 33a. As the first rotating holder 33 rotates counterclockwise, the first lower projection 33c may press the first lower operating piece 43a, and the first lower operating piece 43a may come into contact with the contact of the first lower detector 41a so that the first lower detector 41a may transmit a contact signal to the controller.

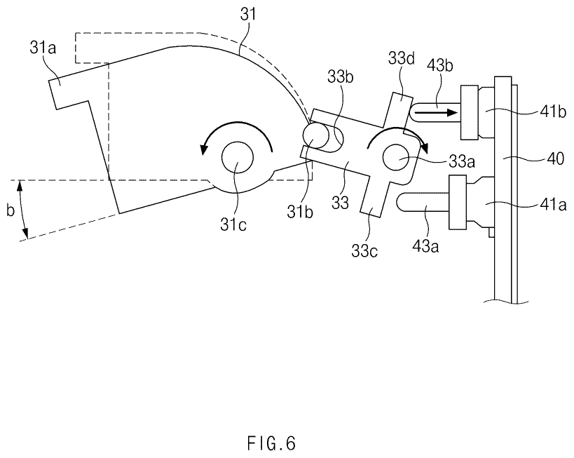

Referring to FIG. 6, when the first knob 31 rotates counterclockwise around the first pivot pin 31c, the first connection pin 31b of the first knob 31 may push the first recess 33b of the first rotating holder 33 upwards so that the first rotating holder 33 may rotate clockwise around the pivot pin 33a. As the first rotating holder 33 rotates clockwise, the first upper projection 33d may press the first upper operating piece 43b, and the first upper operating piece 43b may come into contact with the contact of the first upper detector 41b so that the first upper detector 41b may transmit a contact signal to the controller.

The second knob 32 may be pivotally mounted with respect to the switch housing 35 by a second pivot pin 32c. The second pivot pin 32c may be located in a lower portion of the second knob 32. According to an embodiment, the pair of second knobs 32 may be configured to control the vertical movement of the pair of rear windows, respectively. The pair of rear windows may be configured to move in the pair of rear doors, respectively.

Referring to FIG. 4, the second knob 32 may include a second projection 32a provided on a front portion thereof, and a second connection pin 32b provided on a rear portion thereof. The second projection 32a may extend horizontally from the front portion of the second knob 32. The second connection pin 32b may be located behind the second pivot pin 32c, and the second connection pin 32b may have a circular cross section.

Referring to FIG. 4, a second rotating holder 34 may be horizontally aligned with the second knob 32, and the second rotating holder 34 may be connected to the second connection pin 32b of the second knob 32. The second rotating holder 34 may be pivotally mounted on the switch housing 35 by a pivot pin 34a. The second rotating holder 34 may have a second recess 34b receiving the second connection pin 32b of the second knob 32. The second recess 34b may be provided in a front portion of the second rotating holder 34, and the pivot pin 34a may be located behind the second recess 34b.

The second rotating holder 34 may be connected to the second knob 32 to pivot in the opposite direction to the second knob 32. Referring to FIG. 4, the second connection pin 32b of the second knob 32 may be received in the second recess 34b of the second rotating holder 34 so that the second knob 32 and the second rotating holder 34 may be pivotally connected to each other. The second connection pin 32b of the second knob 32 and the second recess 34b of the second rotating holder 34 may be located between the second pivot pin 32c of the second knob 32 and the pivot pin 34a of the second rotating holder 34.

Referring to FIG. 4, the second rotating holder 34 may include a second lower projection 34c extending downwardly from a bottom surface thereof, and a second upper projection 34d extending upwardly from a top surface thereof.

Referring to FIG. 4, a second lower operating piece 44a may be aligned to contact the second lower projection 34c of the second rotating holder 34, and the second lower operating piece 44a may extend horizontally. A second upper operating piece 44b may be aligned to contact the second upper projection 34d of the second rotating holder 34, and the second upper operating piece 44b may extend horizontally.

Referring to FIG. 4, a second lower detector 42a may be connected to the second lower operating piece 44a, and the second lower detector 42a may be horizontally aligned with the second lower operating piece 44a. A second upper detector 42b may be connected to the second upper operating piece 44b, and the second upper detector 42b may be horizontally aligned with the second upper operating piece 44b. The second lower detector 42a and the second upper detector 42b may be mounted on the PCB 40, and the second lower detector 42a may be located below the second upper detector 42b. According to an embodiment, the second lower detector 42a and the second upper detector 42b may be a tact switch having an elastic movable contact or an elastic member.

The operations of the second knob 32 and the second rotating holder 34 may be substantially the same as those of the first knob 31 and the first rotating holder 33.

A bottom surface of the second knob 32 may be located higher than a top surface of the first knob 31, and the first knob 31 and the second knob 32 may be arranged in a stepwise manner. The first knob 31 and the second knob 32 may be spaced apart from each other by a minimum distance preventing the first knob 31 and the second knob 32 from interfering with each other. Referring to FIG. 4 (see dotted lines in FIG. 4), when the first knob 31 pivots upwards and the second knob 32 pivots downwards, the first knob 31 and the second knob 32 may be spaced apart from each other by a predetermined distance “s” so that the first knob 31 and the second knob 32 may be prevented from interfering with each other.

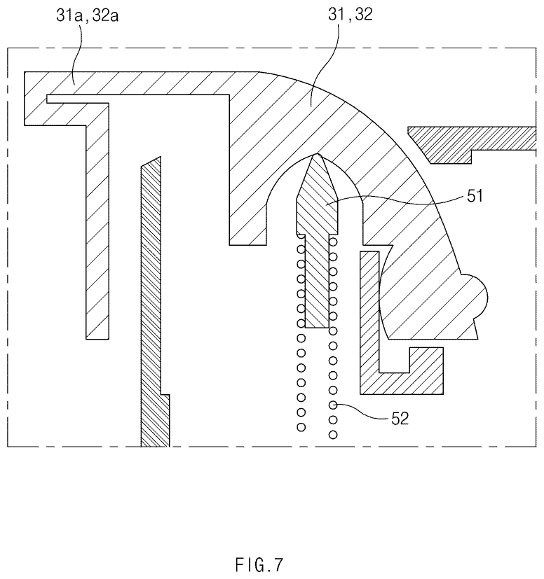

Referring to FIG. 7, each of the knobs 31 and knob 32 may be vertically supported by a support member 51, and the support member 51 may be elastically supported by a spring 52. A top end of the support member 51 may contact a cam surface formed in the inside of each of the knobs 31 and knob 32. The support member 51 and the spring 52 may extend vertically in the switch housing 35.

As described above, the top surface of the second knob 32 may be located higher than the top surface of the first knob 31, and accordingly the first knob 31 and the second knob 32 may be arranged in a stepwise manner. By designing the heights of the knobs 31 and 32 to be different from each other, intuitive operation of the knobs may be facilitated and enhanced, and thus operation errors thereof may be avoided or prevented.

The distance “s” between the first knob 31 and the second knob 32 may be minimized while preventing the first knob 31 and the second knob 32 from interfering with each other. The second projection 32a of the second knob 32 may be at least partially overlapped with the rear portion of the first knob 31, and accordingly the distance “s” between the first knob 31 and the second knob 32 may be minimized so that the length of the switch housing 35 may be significantly reduced. For example, when the switch housing 35 is mounted on the armrest 5 of the vehicle, the support area 5a of the armrest 5 may be relatively increased as the length of the switch housing 35 is reduced.

As set forth above, the power window switch apparatus according to embodiments of the present disclosure may be designed to have the knobs at different heights, thereby facilitating the intuitive operation of the knobs. Thus, the operation errors of the knobs may be avoided or prevented.

According to embodiments of the present disclosure, as the knobs are located at different heights, the distance between the knobs may be reduced. Accordingly, the size of the power window switch apparatus may be reduced so that the area of the armrest occupied by the power window switch apparatus may be reduced. Thus, the support area of the armrest supporting a user's arm or hand may be relatively increased.

Hereinabove, although the present disclosure has been described with reference to some embodiments and the accompanying drawings, the present disclosure is not limited thereto, but may be variously modified and altered by those having ordinary skill in the art to which the present disclosure pertains without departing from the spirit and scope of the present disclosure claimed in the following claims.

What is claimed is:

1. A power window switch apparatus, comprising:
a switch housing;
a first knob pivotally mounted on the switch housing by a first pivot pin; and
a second knob pivotally mounted on the switch housing by a second pivot pin,
wherein a top surface of the second knob is located higher than a top surface of the first knob.

2. The power window switch apparatus according to claim 1, further comprising:
a first front operating piece configured to extend vertically and disposed below a front portion of the first knob;
a first rear operating piece configured to extend vertically and disposed below a rear portion of the first knob;
a first front detector located below the first front operating piece; and
a first rear detector located below the first rear operating piece.

3. The power window switch apparatus according to claim 2, wherein the first front operating piece is located in front of the first pivot pin, and
the first rear operating piece is located behind the first pivot pin.

4. The power window switch apparatus according to claim 2, further comprising:
a second front operating piece configured to extend vertically and disposed below a front portion of the second knob;
a second rear operating piece configured to extend vertically and disposed below a rear portion of the second knob;
a second front detector located below the second front operating piece; and
a second rear detector located below the second rear operating piece.

5. The power window switch apparatus according to claim 4, wherein the second front operating piece is located in front of the second pivot pin, and
the second rear operating piece is located behind the second pivot pin.

6. The power window switch apparatus according to claim 4, further comprising a printed circuit board (PCB) extending horizontally in the switch housing,
wherein the first front detector, the first rear detector, the second front detector, and the second rear detector are mounted on the PCB.

7. The power window switch apparatus according to claim 1, further comprising:
a first rotating holder connected to the first knob to pivot in an opposite direction to the first knob, and including a first lower projection extending downwardly and a first upper projection extending upwardly;
a first lower operating piece aligned to contact the first lower projection of the first rotating holder;
a first upper operating piece aligned to contact the first upper projection of the first rotating holder;
a first lower detector connected to the first lower operating piece; and
a first upper detector connected to the first upper operating piece.

8. The power window switch apparatus according to claim 7, wherein the first knob includes a first connection pin provided on a rear portion thereof, and
the first rotating holder includes a first recess configured to receive the first connection pin.

9. The power window switch apparatus according to claim 7, further comprising:
a second rotating holder connected to the second knob to pivot in an opposite direction to the second knob, and including a second lower projection extending downwardly and a second upper projection extending upwardly;
a second lower operating piece aligned to contact the second lower projection of the second rotating holder;
a second upper operating piece aligned to contact the second upper projection of the second rotating holder;
a second lower detector connected to the second lower operating piece; and
a second upper detector connected to the second upper operating piece.

10. The power window switch apparatus according to claim 9, wherein the second knob includes a second connection pin provided on a rear portion thereof, and
the second rotating holder includes a second recess configured to receive the second connection pin.

11. The power window switch apparatus according to claim 9, further comprising a printed circuit board (PCB) extending vertically in the switch housing,
wherein the first lower detector, the first upper detector, the second lower detector, and the second upper detector are mounted on the PCB.
